(19) United States
(12) Patent Application Publication
(10) Pub. No.: US 2005/0215746 A1
(43) Pub. Date: Sep. 29, 2005

(54) Methods for preparing polymers in carbon dioxide having reactive functionality

(75) Inventors: Joseph M. DeSimone, Chapel Hill, NC (US); Jennifer L. Young, Wilmington, DE (US)

Correspondence Address: MYERS BIGEL SIBLEY & SAJOVEC, PO BOX 37428, RALEIGH, NC, 27627, US

(73) Assignees: North Carolina State University; The University of North Carolina at Chapel Hill

(21) Appl. No.: 11/125,657

(22) Filed: May 10, 2005

Related U.S. Application Data
(63) Continuation of application No. 09/971,552, filed on Oct. 4, 2001.
Application No. 09/971,552 is a continuation-in-part of application No. 09/685,409, filed on Oct. 9, 2000, now abandoned.

(51) Int. Cl. C08G 85/00

(52) U.S. Cl. 526/942; 528/12; 528/421; 528/44; 528/222; 528/271; 528/422

(57) ABSTRACT

A method of forming a polymer having reactive functionality comprises providing a reaction mixture comprising at least one monomer having at least one reactive functional group and carbon dioxide; and polymerizing the at least one monomer in the reaction mixture to form a polymer having reactive functionality associated with the at least one reactive functional group.

### CLAIM FOR PRIORITY AND CROSS-REFERENCE TO OTHER APPLICATIONS

This application claims priority to and is a continuation of parent application Ser. No. 09/971,552, filed Oct. 4, 2001, which is a continuation-in-part of parent application Ser. No. 09/685,409, filed Oct. 9, 2000, the disclosures of which are hereby incorporated herein by reference.

### FIELD OF THE INVENTION

The invention generally relates to processes for preparing polymers in carbon dioxide.

### BACKGROUND OF THE INVENTION

Highly reactive monomers, for example isocyanates, are often useful as modifiers for a number of polymers employed in various applications, particularly coatings and adhesive applications. As an example, isocyanates having vinyl groups are especially useful. In particular, the isocyanate group often serves as the site for chemical modification or grafting to yield a macromonomer and the vinyl group is employed for polymerization. See e.g. Levesque, G., et al., Polymer 1988, 29, pp. 2271-2276 and Liu, Q., et al., J. Biomed. Mater. Res. 1998, 40, pp. 257-263. Such monomers may also be copolymerized with other olefinically unsaturated monomers.

From a processing perspective, polymerizing highly reactive monomers (e.g., isocyanate monomers) is often difficult since they are typically highly reactive with water and alcohols. Suspension polymerizations involving isocyanate monomers have been conducted in perfluorocarbon solvents. See e.g., Zhu, D-W, Polymer Preprints 1995, 36, pp. 249-250 and Zhu, D-W, Macromolecules 1996, 29, pp. 2813-2817. Notwithstanding any developments, there remains a need in the art for polymerization processes involving reactive monomers that may be carried out in a potentially more environmentally benign media.

### SUMMARY OF THE INVENTION

In one aspect, the invention relates to a method of forming a polymer having reactive functionality. The method comprises providing a reaction mixture comprising at least one monomer having at least one reactive functional group and carbon dioxide; and polymerizing the at least one monomer in the reaction mixture to form a polymer having reactive functionality associated with the at least one reactive functional group.

These and other aspects and advantages are provided by the present invention.

### DETAILED DESCRIPTION OF THE PREFERRED EMBODIMENTS

The present invention now will be described more fully hereinafter with reference to the accompanying specification and examples, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

In one aspect, the invention relates to a method of forming a polymer having reactive functionality. The method comprises providing a reaction mixture comprising at least one monomer having at least one reactive functional group and carbon dioxide; and polymerizing the at least one monomer in the reaction mixture (e.g., carbon dioxide) to form a polymer having reactive functionality associated with the at least one reactive functional group. In a preferred embodiment, the monomer has at least one vinyl group, and an initiator is present in the reaction mixture.

For the purposes of the invention the term “reactive functional group” may be defined as an electrophilic functional group susceptible to reaction with a nucleophile. Various reactive functional groups include, without limitation, isocyanate, epoxy, aldehyde, carboxylic acid, acid halide, acetoxy, alkoxy silane, silyl halide, anhydride, ketone, amide, and melamine. In general, the monomers, without limitation, are olefinically unsaturated monomers that contain at least one pendant reactive functional group described hereinabove. Various monomers include, without limitation, isocyanate-containing monomers (e.g., isocyanatoethyl methacrylate and α, α-dimethyl-3-isopropenyl benzyl isocyanate), epoxy-containing monomers (e.g., glycidyl acrylate, glycidyl methacrylate and allyl glycidyl ether), aldehyde-containing monomers (e.g., acrolein and methacrolein), ketone-containing monomers (e.g., vinyl methyl ketone and methyl isopropenyl ketone), amide-containing monomers (e.g. acrylamide and methacrylamide), carboxylic acid-containing monomers (e.g., acrylic acid and methacrylic acid), acid halide-containing monomers (e.g., acryloyl chloride and methacryloyl chloride), acetoxy-containing monomers (e.g. 2-(methacryloyloxy)ethyl acetoacetate), alkoxy silane-containing monomers (e.g. 3-(trimethoxysilyl)propyl methacrylate and 3-(triethoxysilyl)propyl acrylate) silyl halide-containing monomers (e.g. 3-(chlorodimethylsilyl)propyl methacrylate) anhydride-containing monomers (e.g. acrylic anhydride, maleic anhydride), and melamine.

In one embodiment, it is preferred to use monomers containing isocyanate functionality. Exemplary monomers of this type include, without limitation, 2-isocyanatoethyl methacrylate, and α, α-dimethyl-3-isopropenyl benzyl isocyanate.

The monomers may be used in various amounts relative to the carbon dioxide. For the purposes of the invention, the monomers preferably are employed in an amount ranging from about 1, 10, or 20 to about 50, 60, or 70 percent based on the weight of the carbon dioxide, and more preferably from about 5 percent to about 30 percent.

For the purposes of the invention, the term “polymer” is to be broadly construed to mean homopolymer, copolymer, terpolymer, or the like. Accordingly, the monomer may be polymerized to form a homopolymer, or alternatively may be polymerized with at least one additional monomer to form a copolymer (e.g., block, random, graft, or others), terpolymer, and the like. Examples of suitable additional monomers are those that are olefinically unsaturated and include, without limitation, ester monomers (e.g., methyl acrylate, methyl methacrylate, ethyl acrylate, ethyl methacrylate, butyl acrylate, butyl methacrylate, 2-ethylhexyl acrylate, isobutyl methacrylate, and n-propyl methacrylate), vinyl chloride, vinyl acetate, ethylene, acrylonitrile, maleic anhydride, dienes (e.g., isoprene, chloroprene, and butadiene), aromatic monomers (e.g., styrene, alpha-methyl styrene, p-methyl styrene, vinyl toluene, ethylstyrene, tert-butyl styrene, monochlorostyrene, dichlorostyrene, vinyl benzyl chloride, vinyl pyridine, vinyl naphthalene, fluorostyrene, and alkoxystyrenes (e.g., p-methoxystyrene)), and monomers that provide cross-linking and branching (e.g., divinyl benzene and di- and triacrylates).

Other additional monomers that may be employed include, without limitation, fluoromonomers such that polymers (e.g., copolymers) are formed by virtue of the method of the invention that have reactive functionality. Exemplary fluoromonomers include, but are not limited to, tetrafluoroethylene (TFE); CF₂═CFR_{f}, where R_{f} is a perfluoroalkyl group having 1 to 10 carbon atoms, preferably hexafluoropropylene (HFP); perfluoro(alkyl vinyl ethers) (PAVE) wherein the alkyl group has from 1 to 10 carbon atoms and may include ether linkages; chlorotrifluoroethylene (CTFE); vinylidene fluoride (VF₂); vinyl fluoride (VF); fluorinated dioxoles such as perfluoro-2-methylene-4-methyl-1,3-dioxole and preferably perfluoro(2,2,-dimethyl-1,3-dioxole); fluorinated alkenyl vinyl ethers such as:
CF₂═CF—O—(CF₂)ₙ—CF═CF₂, wherein n is 1 or 2;
CF₂═CF—(O—CF₂CFR_{f})ₐ-O—CF₂CFR′_{f}SO₂F wherein R_{f} and R′_{f} are independently selected from F, Cl or a perfluorinated alkyl group having 1 to 10 carbon atoms, a is 0, 1 or 2, preferably CF₂═CF—O—CF₂CF(CF₃)-O-CF₂CF₂SO₂F (perfluoro(3,6-dioxa-4-methyl-7-octenesulfonyl fluoride)) and CF₂═CF—O—CF₂CF₂SO₂F (perfluoro(3-oxa-4-pentenesulfonyl fluoride)); and CF₂═CF—(O—CF₂CFR_{f})ₐ—O—CF₂CFR′_{f}CO₂CH₃ wherein R_{f} and R′_{f} are independently selected from F, Cl or a perfluorinated alkyl group having 1 to 10 carbon atoms, a is 0, 1 or 2, preferably CF₂═CF—O—CF₂CF(CF₃)—O—CF₂CF₂CO₂CH₃ and CF₂═CF—O—CF₂CF₂CO₂CH₃. Perfluoroalkylethylenes such as C₄F₉—CH═CH₂ as well as ethylene and/or propylene are suitable comonomers when the above fluoromonomers may also be used.

In embodiments encompassing the polymerization of fluoromonomers, particularly in embodiments encompassing perfluoropolymers, halogenated initiators are preferred. Exemplary initiators are perhalogenated initiators, more preferably perchlorinated initiators, and most preferably perfluorinated initiators. An example of a preferred group of perfluorinated initiators is:

R_{f}—(C═O)—O—O—(C═O)-R_{f}, where R_{f} is a perfluoroalkyl group of 1 to 8 carbon atoms that may contain 0 to 4 ether linkages. Preferred examples are perfluoropropionyl peroxide also known as “3P”, and CF₃CF₂CF₂OCF(CF₃)(C═O)OO(C═O)(CF₃)CFOCF₂CF₂CF₃, also known as HFPO dimer peroxide.

Mixtures of these monomers can also be employed. Other comonomers, without limitation, include the reactive functional monomers listed hereinabove as long as the comonomers used in the copolymerization do not react with each other.

The above olefinically unsaturated comonomer can be used in various amounts. If employed, the reaction mixture preferably comprises from about 1 to about 99 percent by weight of the olefinically unsaturated comonomer based on the weight of the reactive functional monomer.

For the purposes of the invention, the term “polymer having reactive functionality” refers to a polymer (e.g., homopolymer, copolymer, terpolymer, etc.) that has at least one functional group as defined hereinabove. In a preferred embodiment, the resulting polymer may be present in the form of a particle. In these instances, the polymer typically has a diameter ranging from about 0.05 μm to about 10 μm.

In addition, a third monomer may be employed which polymerizes with the at least one monomer having at least one reactive functional group and the additional monomer. Accordingly, in one embodiment, the method of the invention comprises copolymerizing the third monomer with the at least one monomer having at least one reactive functional group and the additional monomer. In one preferred embodiment, the additional monomer is a fluoromonomer. A number of monomers may be employed for the third monomer. Exemplary monomers include, without limitation, ester monomers (e.g., methyl acrylate, methyl methacrylate, ethyl acrylate, ethyl methacrylate, butyl acrylate, butyl methacrylate, 2-ethylhexyl acrylate, isobutyl methacrylate, and n-propyl methacrylate), vinyl chloride, vinyl acetate, ethylene, acrylonitrile, maleic anhydride, dienes (e.g., isoprene, chloroprene, and butadiene), aromatic monomers (e.g., styrene, alpha-methyl styrene, p-methyl styrene, vinyl toluene, ethylstyrene, tert-butyl styrene, monochlorostyrene, dichlorostyrene, vinyl benzyl chloride, vinyl pyridine, vinyl naphthalene, fluorostyrene, and alkoxystyrenes (e.g., p-methoxystyrene)), and monomers that provide cross-linking and branching (e.g., divinyl benzene and di- and triacrylates). Particularly preferred third monomers are perfluoroalkylethylenes, ethylene, propylene, and mixtures thereof.

For the purposes of the invention, carbon dioxide is employed in a liquid or supercritical phase. The reaction mixture typically employs carbon dioxide as a continuous phase, with the reaction mixture (initiator, monomer, and other optional components) typically comprising from about 1 to about 80 percent by weight of carbon dioxide. If liquid CO₂ is used, the temperature employed during the process is preferably below 31° C. In one preferred embodiment, the CO₂ is utilized in a “supercritical” phase. As used herein, “supercritical” means that a fluid medium is at a temperature that is sufficiently high that it cannot be liquefied by pressure. The thermodynamic properties of CO₂ are reported in Hyatt, J. Org. Chem. 49: 5097-5101 (1984); therein, it is stated that the critical temperature of CO₂ is about 31° C. In particular, the methods of the present invention are preferably carried out at a temperature range from about −20° C. to about 100° C. The pressures employed preferably range from about 200 psia (1.4 MPa) to about 10,000 psia (69 MPa).

Initiators that may be used in the method of the invention are numerous and known to those skilled in the art. Examples of initiators are set forth in U.S. Pat. No. 5,506,317 to DeSimone et al., the disclosure of which is incorporated by reference herein in its entirety. Organic free radical initiators are preferred and include, but are not limited to, the following:
acetylcyclohexanesulfonyl peroxide; diacetyl peroxydicarbonate; dicyclohexyl peroxydicarbonate; di-2-ethylhexyl peroxydicarbonate; tert-butyl perneodecanote, 2,2′-azobis(methoxy-2,4-dimethylvaleronitrile); tert-butyl perpivalate; dioctanoyl peroxide; dilauroyl peroxide; 2,2′-azobis(2,4-dimethylvaleronitrile); tert-butylazo-2-cyanobutane; dibenzoyl peroxide; tert-butyl per-2-ethylhexanoate; tert-butyl permaleate; 2,2-azobis(isobutyronitrile); bis(tert-butylperoxy) cyclohexane; tert-butyl peroxyisopropylcarbonate; tert-butyl peracetate; 2,2-bis(tert-butylperoxy) butane; dicumyl peroxide; ditert-amyl peroxide; di-tert-butyl peroxide; p-methane hydroperoxide; pinane hydroperoxide; cumene hydroperoxide; and tert-butyl hydroperoxide. Combinations of any of the above initiators can also be used. Preferably, the initiator is azobis(isobutyronitrile) (“AIBN”).

The initiator may be used in varying amounts. Preferably, the reaction mixture comprises from about 0.001 to about 20 percent initiator by weight of the total reaction mixture (e.g., the homogeneous mixture).

Optionally, the reaction mixture of the invention may include a surfactant known to those skilled in the art. Preferably, the surfactants are non-ionic surfactants. Examples of suitable surfactants are set forth in U.S. Pat. Nos. 5,783,082; 5,589,105; 5,639,836; and 5,451,633 to DeSimone et al.; U.S. Pat. No. 5,676,705; and 5,683,977 to Jureller et al., the disclosures of which are incorporated herein by reference in their entirety. In general, the surfactant may encompass any macromolecule that serves to emulsify, and may be polymeric or non-polymeric.

Preferably, the surfactant has a segment that has an affinity for the material it comes in contact with, or, stated differently, a “CO₂-phobic segment”. Exemplary CO₂-phobic segments may comprise common lipophilic, oleophilic, and aromatic polymers, as well as oligomers formed from monomers such as ethylene, a-olefins, styrenics, acrylates, methacrylates, ethylene oxides, isobutylene, vinyl alcohols, acrylic acid, methacrylic acid, and vinyl pyrrolidone. The CO₂-phobic segment may also comprise molecular units containing various functional groups such as amides; esters; sulfones; sulfonamides; imides; thiols; alcohols; dienes; diols; acids such as carboxylic, sulfonic, and phosphoric; salts of various acids; ethers; ketones; cyanos; amines; quaternary ammonium salts; and thiozoles. Mixtures of any of these components can make up the “CO₂-phobic segment”. If desired, the surfactant may comprise a plurality of “CO₂-phobic” segments. The CO₂-phobic segment preferably will not contain a functional group that will react with the reactive functional group of the olefinically unsaturated monomer.

If desired, the surfactant may comprise a segment that has an affinity for carbon dioxide, or a “CO₂-philic” segment. Exemplary CO₂-philic segments may include a halogen (e.g., fluoro or chloro)-containing segment, a siloxane-containing segment, a branched polyalkylene oxide segment, or mixtures thereof. Examples of “CO₂-philic” segments are set forth in U.S. Pat. Nos. 5,676,705; and 5,683,977 to Jureller et al., as well as U.S. Pat. Nos. 5,783,082; 5,589,105; 5,639,836; and 5,451,633 to DeSimone et al. If employed, the fluorine-containing segment is typically a “fluoropolymer”. As used herein, a “fluoropolymer” has its conventional meaning in the art and should also be understood to include low molecular weight oligomers, i.e., those which have a degree of polymerization greater than or equal to two. See generally Banks et al., Organofluorine Compounds: Principals and Applications (1994); see also Fluorine-Containing Polymers, 7 Encyclopedia of Polymer Science and Engineering 256 (H. Mark et al. Eds. 2d Ed. 1985). Exemplary fluoropolymers are formed from monomers which may include fluoroacrylate monomers such as 2-(N-ethylperfluorooctane-sulfonamido) ethyl acrylate (“EtFOSEA”), 2-(N-ethylperfluorooctane-sulfonamido) ethyl methacrylate (“EtFOSEMA”), 2-(N-methylperfluorooctane-sulfonamido) ethyl acrylate (“MeFOSEA”), 2-(N-methylperfluorooctane-sulfonamido) ethyl methacrylate (“MeFOSEMA”), 1,1′-dihydroperfluorooctyl acrylate (“FOA”), 1,1′-dihydroperfluorooctyl methacrylate (“FOMA”), 1,1′,2,2′-tetrahydroperfluoroalkylacrylate, 1,1′,2,2′-tetrahydroperfluoroalkyl-methacrylate and other fluoromethacrylates; fluorostyrene monomers such as a-fluorostyrene and 2,4,6-trifluoromethylstyrene; fluoroalkylene oxide monomers such as hexafluoropropylene oxide and perfluorocyclohexane oxide; fluoroolefins such as tetrafluoroethylene, vinylidine fluoride, and chlorotrifluoroethylene; and fluorinated alkyl vinyl ether monomers such as perfluoro(propyl vinyl ether) and perfluoro(methyl vinyl ether). Copolymers using the above monomers may also be employed. Exemplary siloxane-containing segments include alkyl, fluoroalkyl, and chloroalkyl siloxanes. More specifically, dimethyl siloxanes and polydimethylsiloxane materials are useful. Mixtures of any of the above may be used. In certain embodiments, the “CO₂-philic” segment may be covalently linked to the “CO₂-phobic” segment.

For the purposes of the invention, one cannot employ a CO₂-phobic segment alone as the surfactant since it would not be sufficiently soluble in CO₂. One can however use a CO₂-philic segment solely as a surfactant.

Surfactants that are suitable for the invention may be in the form of, for example, homo, random, block (e.g., di-block, tri-block, or multi-block), blocky (those from step growth polymerization), and star homopolymers, copolymers, and co-oligomers. Exemplary homopolymers include, but are not limited to, poly(1,1′-dihydroperfluorooctyl acrylate) (“PFOA”), poly(1,1′-dihydro-perfluorooctyl methacrylate) (“PFOMA”), poly(2-(N-ethylperfluorooctane-sulfonamido) ethyl methacrylate) (“PEtFOSEMA”), and poly(2-(N-ethylperfluorooctane sulfonamido) ethyl acrylate) (“PEtFOSEA”). Exemplary block copolymers include, but are not limited to, polystyrene-b-poly(1,1-dihydroperfluorooctyl acrylate), polymethyl methacrylate-b-poly(1,1-dihydroperfluorooctyl methacrylate), poly(2-(dimethylamino)ethyl methacrylate)-b-poly(1,1-dihydroperfluorooctyl methacrylate), and a diblock copolymer of poly(2-hydroxyethyl methacrylate) and poly(1,1-dihydroperfluorooctyl methacrylate). Statistical copolymers of poly(1,1-dihydroperfluorooctyl acrylate) and polystyrene, along with poly(1,1-dihydroperfluorooctyl methacrylate) and poly(2-hydroxyethyl methacrylate) can also be used. A preferred block copolymer is polystyrene-b-poly(1,1′-dihydroperfluorooctyl acrylate) (“PS-b-PFOA”). Graft copolymers may be also be used and include, for example, poly(styrene-g-dimethylsiloxane), poly(methyl acrylate-g-1,1′dihydroperfluorooctyl methacrylate), and poly(1,1′-dihydroperfluorooctyl acrylate-g-styrene). For the purposes of the invention, multiple surfactants may be employed in the invention, if so desired.

Although a number of examples of surfactants listed herein are in the form of block, random, or graft copolymers, it should be appreciated that other copolymers that are not block, random, or graft may be used.

If employed, the amount of surfactant that is used in the reaction mixture may be selected from various values. Preferably, the fluid mixture comprises from about 0.01 to about 30 percent by weight of the surfactant, and more preferably from about 1 to about 20 percent by weight. It should be appreciated that this amount depends on several factors including the stability of the surfactant and desired end product. In a preferred embodiment, the surfactant should be selected such that it does not react with the reactive functional polymer.

The reaction mixture may also comprise components in addition to those described above. Exemplary components include, but are not limited to, polymer modifier, water, rheology modifiers, plasticizing agents, antibacterial agents, flame retardants, and viscosity reduction modifiers. Co-solvents and co-surfactants may also be optionally employed. These components may be used if they do not react with the reactive functional polymer.

The methods of the invention may take place using known equipment. For example, the polymerization reactions may be carried out either batchwise, continuously, or semi-continuously, in appropriately designed reaction vessels or cells. Additional features may be employed such as, for example, agitation devices (e.g., a paddle stirrer or impeller stirrer) and heaters (e.g., a heating furnace, heating rods, or a heating rope). Typically, the initiator, monomer or monomers, surfactants, carbon dioxide, and other optional ingredients are added to the vessel or cell and the reaction begins by heating the reaction vessel or cell to a temperature above about 30° C. (preferably between about 55° C. and about 75° C. The temperature of the reaction may depend on various factors such as, for example, the type of initiator employed. Preferably, the mixture is allowed to polymerize for between about 4 h and 24 h and preferably is stirred as the reaction proceeds. At the conclusion of the reaction, the polymer can be collected by methods known to one skilled in the art such as, without limitation, venting of the carbon dioxide, or by fractionation. Preferably, the surfactant is fractionated from the carbon dioxide and polymer by supercritical fluid extraction, and thus is able to be reused if so desired. After separation, the polymer can be collected by conventional means. In addition, the polymers of the present invention may be retained in the carbon dioxide, dissolved in a separate solvent evaporate, and applied (e.g., sprayed) to a substrate surface. After the carbon dioxide and solvent evaporate, the polymer forms a coating on the surface of the substrate.

As alluded to in greater detail herein, composite particles containing two or more distinct polymers, copolymers, etc. can be made in accordance with the invention, and usually encompasses forming these materials in two distinct polymerization stages utilizing, for example, conditions set forth herein.

In another embodiment, the invention may optionally further include the step of reacting the polymer containing reactive functionality with a second polymer containing reactive functionality such that the polymers containing reactive functionality crosslink, i.e., chemically crosslink. Examples of second polymers containing reactive functionality include, without limitation, ones that contain a nucleophilic functional group, such as alcohols (e.g., poly(hydroxyethyl acrylate) and poly(hydroxyethyl methacrylate)), primary and secondary amines (e.g. poly(2-aminoethyl methacrylate), poly(2-(tert-butylamino)ethyl methacrylate), and poly(2-(iso-propylamino)ethyl styrene)), and alkyl halides (e.g. poly(2-chloroethyl methacrylate). In a specific embodiment, the polymer containing reactive functionality may be applied with the second polymer containing reactive functionality to the substrate described herein such that these polymers become crosslinked. Moreover, in another embodiment, the polymer contains isocyanate reactive functionality and the second polymer contains an alcohol such that a urethane linkage is present between the two polymers. The crosslinking of the these polymers can be carried out using techniques that are known to one skilled in the art, and can be monitored by known means such as, for example, FTIR spectroscopy.

In another embodiment, the reactive functional polymer may react with a molecule containing a reactive functional group. Examples of such molecules include those containing a nucleophilic functional group such as, without limitation, an alcohol (e.g. methanol and octanol), a primary amine (e.g. ethylamine and 1-decylamine), a secondary amine (e.g. dimethylamine, diethylamine, and pyrrolidine), an alkyl halide (e.g. 1-chloropropane), and an amino acid (e.g. alanine and lysine). Other molecules that can be reacted with the reactive functional polymer, include, but are not limited to, peptides, enzymes (e.g. lipase and esterase), and proteins (e.g. insulin and bovine serum albumin). Combinations thereof can also be employed.

Optionally, the method of the invention may include other steps. For example, in one embodiment, the method may include separating the polymer containing reactive functionality from the reaction mixture. Preferably, the method further comprises applying the polymer containing reactive functionality to a substrate. Techniques for separating the polymer and applying to a substrate are known in the art and are described, for example, in U.S. Pat. No. 5,863,612 to DeSimone et al., the disclosure of which is incorporated herein by reference in its entirety. Examples of methods for separating the polymer include, without limitation, boiling off the carbon dioxide and leaving the polymer behind, and precipitation of the polymer into a non-solvent either by introducing a non-solvent to the reactor or the transfer of the reactor contents to another vessel containing a non-solvent for the polymer. In one embodiment, the separation and application steps may be carried out together and include, as an example, passing (e.g., spraying or spray-drying) a solution containing the polymer through an orifice to form particles, powder coatings, fibers, and other coatings on the substrates. A wide variety of substrates may be employed such as, without limitation, metals, organic polymers, inorganic polymers, textiles, and composites thereof. These application techniques are demonstrated for liquid and supercritical solutions.

Optionally, the polymer containing reactive functionality may be applied with a second polymer having reactive functionality to the substrate, and the polymers may thereafter be crosslinked by known techniques to form a crosslinked polymer coating on the substrate.

In another embodiment in which the polymer is in the form of a solid particle, the method of the invention may further include the step of polymerizing at least one additional monomer having ethylenic unsaturation in the presence of the solid particle to form a second polymer that becomes attached (either physically or chemically) to the solid particle to form a composite particle. Various olefinically unsaturated monomers can be used including, without limitation, those described hereinabove. Copolymers, terpolymers, and the like can also be formed in which case more than one monomer would be polymerized.

The following examples are intended to illustrate the invention and are not intended as a limitation thereon. In the examples, isocyanatoethyl methacylate (IEM), azobis(isobutyronitrile) (AIBN), glycidyl methacrylate (GMA), hydroxyethyl methacrylate (HEMA), methyl methacrylate (MMA) and styrene (STY) were provided by Aldrich of St. Louis, Mo., with the AIBN being recrystallized from methanol. Styrene and MMA were deinhibited by passage through an alumina column made commercially available by Aldrich. Carbon dioxide was provided by Air Products and Chemicals, Inc. of Allentown, Pa. Tetrahydrofuran (THF) was made commercially available by Mallinckrodt of Paris, Ky. and HPLC grade THF was made commercially available by Allied Signal of Muskegon, Mich. PS-b-PFOA surfactant (4.2 K/37.5 K) was synthesized by Hiroshi Shiho.

A high pressure variable volume reactor was employed in the examples. The reactor has a maximum volume of 39 mL and is a HiP pressure generator modified with three ports and a sapphire window on the end for visual observations. The window and ports of the reactor are described in detail in Lemert, R. et al. J. Supercrit. Fluids 1990, 4, 186. One of the ports contains a thermocouple which is used to monitor the reactor temperature, another port is connected to a 2-way valve used for second-stage monomer addition and for venting, and the third port is connected to a 3-way valve. One side of the 3-way valve leads to a rupture disk housing and pressure transducer and the other side is used for the carbon dioxide delivery line. The reactor is equipped with a magnetic cross-shaped stir bar for magnetic stirring and is wrapped with electric heating rope for heating. The reactor is horizontal and tilted such that the stir bar remains against the sapphire window in order to observe whether or not stirring is taking place.

A general synthesis procedure that was used in the examples is as follows. Following the addition of surfactant and initiator to the variable volume reactor through the sapphire window, the reactor was sealed and purged with argon (Ar) for 15 min. The first-stage monomer(s) was degassed with Ar for 15 min and then injected into the reactor under Ar with a syringe through one of the reactor ports. After the reactor was purged another minute with Ar, the carbon dioxide delivery line was purged with carbon dioxide and the reactor was pressurized with carbon dioxide to approximately 70 bar using an ISCO model 260D automatic syringe pump. The reaction mixture was stirred with a magnetic stir bar and heated to 65° C. with electric heating rope. Once the temperature reached 63° C., the reactor was pressurized with carbon dioxide to the final reaction pressure. Initially, the reaction mixture appeared clear and colorless upon reaching the reaction temperature and pressure then progressed from cloudy white to milky white.

In the event that a second-stage polymerization was employed, the second stage monomer(s) with initiator solution was prepared, filtered through a 0.2 μm syringe filter and stored in an ice bath. Carbon dioxide was added to maintain the reaction pressure while the reactor volume was increased. The HPLC pump was primed with HPLC grade THF to remove air and purged with second-stage monomer(s)/initiator solution. The pump was pressurized to the reaction pressure with second stage monomer/initiator solution and run at 1 mL/min until the desired amount was injected. During the addition, the reactor pressure was maintained by manually increasing the reactor volume. The actual amount of second-stage solution added was determined by weighing the solution flask before and after the injection. Immediately following the addition, carbon dioxide was injected into the reactor to clear the injection valve and line of second stage monomer(s)/initiator solution and the reactor volume was increased to maintain the reaction pressure. The dispersion remained stable and milky white in appearance during the entire reaction period, with little if any polymer precipitation or settling even when the stirring was momentarily stopped. After the second-stage reaction time of 24 hr, the reactor was rapidly cooled to 25° C. in an ice bath. Thereafter, the carbon dioxide was slowly vented into hexane. Dry polymer powder was recovered from the reactor and the remaining polymer was recovered with THF. Polymer was dried under vacuum overnight and the yield was determined gravimetrically.

### EXAMPLE 1

### Homopolymerization of Isocyanatoethyl Methacrylate

A variable volume reactor having an initial size of 11 mL was purged with argon and heated to 100° C. for an hour and then cooled prior to the addition of reactants. Through a sapphire window opening was added 0.1 g of PS-b-PFOA (4.2 K/37.5 K) and AIBN having a concentration of 0.07 M in IEM to the reactor and the reactor was thereafter sealed and purged with argon for 15 minutes. IEM in the amount of 0.73 mL was added in the manner set forth above. The reaction pressure was 365 bar. The polymerization proceeded for at least 20 h. The IEM was successfully polymerized to form poly(isocyanatoethyl methacrylate) (PIEM).

### EXAMPLE 2

### Polymerization of Styrene in the Presence of PIEM

Styrene was polymerized in the presence of the PIEM particles formed in Example 1 to form composite particles. Following the polymerization in Example 1, the reactor volume was increased at constant pressure to 17 mL. Thereafter, 1.6 g of a solution of 0.11 M AIBN in STY was added to the reactor employed in Example 1. The final volume of the system was 19 mL. The pressure employed during this reaction was 360 bar carbon dioxide. The target mol ratio percent of PIEM to polystyrene (PS) was 20:80.

### EXAMPLE 3

### Copolymerized Composite Polymer Particle

A copolymerized composite polymer particle was formed according to the below procedure. In the reactor described in Example, 0.6 mL containing IEM and methyl methacrylate (MMA) in a 20:80 mol percent ratio respectively were copolymerized having an initial volume of 9 mL using 0.1 g of the same surfactant. AIBN (0.03 M) was used as initiator. The reaction pressure was 365 bar. After particles of copolymerized PIEM and PMMA were formed, the reactor volume was increased at constant pressure to 17 mL. HEMA and styrene (2 gms) in a 5:95 mol percent ratio respectively were injected into the reactor and copolymerized using 0.11 M AIBN as the initiator. The volume during addition was determined to be 17 mL. The reaction pressure was 360 bar. The final volume of the system was 19 mL. The target mol ratio percent of IEM:PMMA:PHEM:PS was 4:16:4:76.

### EXAMPLE 4

### Homopolymerization of Glycidyl Methacrylate

Glycidyl methacrylate (GMA) was polymerized using the reactor described in Example 1. To the reactor was added 1.4 mL of GMA, the reactor having an initial volume of 10 mL. The pressure of carbon dioxide was 390 bar. 0.44 g of PS-b-PFOA (4.2 K/19.7 K) and AIBN having a concentration of 0.06 M in the GMA were added to the reactor through a sapphire window opening and the reactor was thereafter sealed. The reaction proceeded for at least 20 h such that the formation of PGMA occurred.

### EXAMPLE 5

### Polymerization of Styrene in the Presence of PGMA

STY was polymerized in the presence of the PGMA particles formed in Example 5 to form composite particles. Following the polymerization of 0.7 mL of GMA with 0.22 g of surfactant in the reactor with a volume of 12 mL according to Example 4, the reactor volume was increased at constant pressure to 17 mL. To the reactor employed in Example 1 was added 1.6 g of STY in a volume of 17 mL using 0.22 g of surfactant. AIBN was used as initiator at a concentration of 0.11 M. The final volume of the system was 19 mL. The reaction pressure was 390 bar. The reaction proceeded for at least 20 h. The target mol ratio percent of PGMA to PS was 20:80.

### EXAMPLE 6

### Copolymerized Composite Polymer Particle

A copolymerized composite polymer particle was formed according to the below procedure. GMA and MMA (0.58 mL) in a 20:80 mol percent ratio respectively were copolymerized in the reactor described in Example 1 having an initial volume of 11 mL using 0.12 g of PS-b-PFOA (4.2 K/19.7 K) as surfactant. AIBN (0.03 M) was used as initiator. The reaction pressure was 390 bar. Particles of copolymerized PIEM and PMMA were formed. The reactor volume was increased to 17 mL at a constant pressure. Using 0.11 M AIBN as initiator, 1.6 gms of STY was thereafter polymerized. The volume during addition was determined to be 17 mL. The final volume of the system was 19 mL. The second stage pressure was 370 bar. The reaction proceeded for 20 h. The target mol ratio percent of PGMA:PMMA:PS was 4:16:80.

In the specification, and examples there have been disclosed typical preferred embodiments of the invention and, although specific terms are employed, they are used in a generic and descriptive sense only and not for the purposes of limitation, the scope of the invention being set forth in the following claims.

1. A method of forming a polymer having reactive functionality, said method comprising:
providing a reaction mixture comprising at least one monomer having at least one reactive functional group and carbon dioxide; and
polymerizing the at least one monomer in the reaction mixture to form a polymer having reactive functionality associated with the at least one reactive functional group.

2. The method according to claim 1, wherein the at least one monomer further includes at least one vinyl group, and the reaction mixture further comprises an initiator.

3. The method according to claim 1, wherein the carbon dioxide is liquid carbon dioxide.

4. The method according to claim 1, wherein the carbon dioxide is supercritical carbon dioxide.

5. The method according to claim 1, wherein at least one monomer is an isocyanate-containing monomer.

6. The method according to claim 1, wherein the at least one monomer is an epoxy-containing monomer.

7. The method according to claim 1, wherein the at least one monomer is a ketone-containing monomer.

8. The method according to claim 1, wherein the at least one monomer is an amide-containing monomer.

9. The method according to claim 1, wherein the at least one monomer is a carboxylic acid-containing monomer.

10. The method according to claim 1, wherein the at least one monomer is an acid halide-containing monomer.

11. The method according to claim 1, wherein the at least one monomer is an acetoxy-containing monomer.

12. The method according to claim 1, wherein the at least one monomer is an alkoxy silane-containing monomer.

13. The method according to claim 1, wherein the at least one monomer is a silyl halide-containing monomer.

14. The method according to claim 1, wherein the at least one monomer is an anhydride-containing monomer.

15. The method according to claim 1, wherein the at least one monomer is melamine.

16. The method according to claim 1, wherein the at least one monomer is an aldehyde-containing monomer.

17. The method according to claim 2, wherein the initiator is selected from the group consisting of acetylcyclohexanesulfonyl peroxide; diacetyl peroxydicarbonate;
dicyclohexyl peroxydicarbonate; di-2-ethylhexyl peroxydicarbonate; tert-butyl perneodecanoate; 2,2′-azobis (methoxy-2,4-dimethylvaleronitrile; tert-butyl perpivalate; dioctanoyl peroxide; dilauroyl peroxide; 2,2′-azobis (2,4-dimethylvaleronitrile); tert-butylazo-2-cyanobutane; dibenzoyl peroxide; tert-butyl per-2-ethylhexanoate; tert-butyl permaleate; 2,2-azobis (isobutyronitrile); bis(tert-butylperoxy) cyclohexane; tert-butyl peroxyisopropylcarbonate; tert-butyl peracetate; 2,2-bis (tert-butylperoxy) butane; dicumyl peroxide; ditertamyl peroxide; di-tert-butyl peroxide; p-methane hydroperoxide; pinane hydroperoxide; cumene hydroperoxide; tert-butyl hydroperoxide; and mixtures thereof.

18. The method according to claim 2, wherein the initiator is azobisisobutyronitrile.

19. The method according to claim 1, wherein the reaction mixture comprises at least one additional monomer, and wherein said polymerizing step comprises polymerizing the at least one monomer having at least one reactive functional group with at least one additional monomer to form a copolymer.

20. The method according to claim 19, wherein the at least one additional monomer is selected from the group consisting of an ester monomer, vinyl chloride, vinyl acetate, ethylene, acrylonitrile, maleic anhydride, a diene, an aromatic monomer, a monomer that provides crosslinking and branching, and mixtures thereof.

21. The method according to claim 19, wherein the at least one additional monomer is a fluoromonomer.

22. The method according to claim 21, wherein the fluoromonomer is selected from the group consisting of tetrafluoroethylene; CF₂═CFR_{f}, where R_{f} is a perfluoroalkyl group having 1 to 10 carbon atoms, perfluoro(alkyl vinyl ethers), chlorotrifluoroethylene, vinylidene fluoride, vinyl fluoride, fluorinated dioxoles, fluorinated alkenyl vinyl ethers, and mixtures thereof.

23. The method according to claim 21, wherein the fluoromonomer is selected from the group consisting of CF₂CF(CF₃)—O—CF₂CF₂CO₂CH₃, CF₂═CF—O—CF₂CF₂CO₂CH₃, CF₂═CF—O—(CF₂)ₙ—CF═CF₂ wherein n is 1 or 2, CF₂═CF—(O—CF₂CFR_{f})ₐ-O—CF₂CFR′_{f}SO₂F wherein R_{f} and R′_{f} are independently selected from F, Cl or a perfluorinated alkyl group having 1 to 10 carbon atoms, a is 1 or 2, CF₂═CF—(O—CF₂CFR_{f})ₐ-O—CF₂CFR′_{f}CO₂CH₃ wherein R_{f} and R′_{f} are independently selected from F, Cl or a perfluorinated alkyl group having 1 to 10 carbon atoms, a is 0, 1 or 2, and mixtures thereof.

24. The method according to claim 21, wherein the reaction mixture further comprises a third monomer which copolymerizes with the at least one monomer having at least one reactive functional group and the fluoromonomer.

25. The method according to claim 24, wherein the third monomer is selected from the group consisting of an ester monomer, vinyl chloride, vinyl acetate, ethylene, acrylonitrile, maleic anhydride, a diene, an aromatic monomer, a monomer that provides crosslinking and branching, and mixtures thereof.

26. The method according to claim 24, wherein the third monomer is selected from the group consisting of perfluoroalkylethylenes, ethylene, propylene, and mixtures thereof.

27. The method according to claim 21, wherein the initiator is a halogented initiator which is a perhalogenated initiator selected from the group consisting of perchlorinated initiators and perfluorinated initiators.

28. The method according to claim 25, wherein the initiator is a perfluorinated initiator of the formula:
Rf—(C═O)—O—O—(C═O)-R_{f}
wherein R_{f} is a perfluoroalkyl group of 1 to 8 carbon atoms that may contain from 0 to 4 ether linkages.

29. The method according to claim 27, wherein the perfluorinated initiator is selected from the group consisting of perfluoropropionyl peroxide and CF₃CF₂CF₂OCF(CF₃)(C═O)OO(C═O)(CF₃)CFOCF₂CF₂CF₃.

30. The method according to claim 1, further comprising the step of reacting the polymer containing reactive functionality with a second polymer containing reactive functionality such that the polymers containing reactive functionality become crosslinked.

31. The method according to claim 29, wherein the second polymer containing reactive functionality is selected from the group consisting of an alcohol, a primary amine, a secondary amine, and an alkyl halide.

32. The method according to claim 1, further comprising the step of separating the polymer containing reactive functionality from the reaction mixture.

33. The method according to claim 32, wherein subsequent to said step of separating the polymer containing reactive functionality from the reaction mixture, said method further comprises the step of applying the polymer containing reactive functionality to a substrate.

34. The method according to claim 33, wherein said step of applying the polymer having reactive functionality comprises applying the polymer with a second polymer containing reactive functionality, and wherein the polymers containing reactive functionality become crosslinked.

35. The method according to claim 1, wherein the reaction mixture further comprises a surfactant.

36. The method according to claim 35, wherein the surfactant comprises a CO₂-philic segment.

37. The method according to claim 36, wherein the CO₂-philic segment comprises a fluoropolymer or a siloxane-containing segment.

38. The method according to claim 36, wherein the surfactant comprises a CO₂-phobic segment.

39. The method according to claim 1, wherein the polymer having reactive functionality is present as a solid particle.

40. The method according to claim 39, further comprising the step of polymerizing at least one additional monomer having ethylenic unsaturation in the presence of the solid particle to form a second polymer that becomes attached to the solid particle to form a composite particle.

41. The method according to claim 40, wherein the at least one additional monomer is selected from the group consisting of an ester monomer, vinyl chloride, vinyl acetate, ethylene, acrylonitrile, maleic anhydride, a diene, a monomer that provides crosslinking and branching, and mixtures thereof.

42. The method according to claim 1, further comprising the step of reacting the polymer having reactive functionality with a molecule containing at least one reactive functional group.

43. The method according to claim 42, wherein the molecule containing at least one reactive functional group is selected from the group consisting of an alcohol, a secondary amine, an alkyl halide, an amino acid, a peptide, an enzyme, a protein, and combinations thereof.

44-72. (canceled)
